(19) United States
(12) Patent Application Publication
(10) Pub. No.: US 2015/0317459 A1
(43) Pub. Date: Nov. 5, 2015

(54) METHOD TO CALCULATE FREE ENERGIES

(71) Applicant: Asaf FARHI, (US)

(72) Inventors: Asaf FARHI, Tel-Aviv (IL); Guy HED, Rehovot (IL)

(21) Appl. No.: 14/651,349

(22) PCT Filed: Dec. 9, 2013
(86) PCT No.: PCT/IL2013/051009

§ 371 Date: Jun. 11, 2015

Related U.S. Application Data
(60) Provisional application No. 61/735,569, filed on Dec. 11, 2012.

(51) Int. Cl. G06F 19/00; G06F 17/10

(52) U.S. Cl. CPC G06F 19/701; G06F 17/10

(57) ABSTRACT

A method to calculate free energies in molecular simulations is described. The coordinates of the molecules (and possibly the atoms) and the interactions are usually given as an input or auto-generated. The free energy difference/s between the original system/s and the system/s with possibly some of the energy terms partly or fully relaxed is calculated by simulating intermediate systems that interpolate between them. The free energy associated with the atoms in which the coupling energy terms are usually totally relaxed, in one possible context will cancel out and in another possible context will be directly calculated. These free energy values can be used to calculate free energies or relative free energies of processes such as (but not limited to) solvation, binding and chemical reactions or free energy difference between states and more.

### 1 TECHNICAL FIELD

The method is in the field of free energy calculations in molecular simulations. Molecular simulations can be in the context of Molecular Dynamics and Monte Carlo simulations. The molecular modeling (force fields) can be atomistic, coarse grained, other or combined. The method suggests, based on molecular coordinates and force fields, to perform molecular simulations and possibly further calculations that will give as an output free energy values (or differences). Based on these values, meaningful free energy values will be derived. These will be used to predict likelyhood of molecular processes, molecular states etc. which are usually determined by experiments. Possible applications are free energies of solvation, binding and chemical reactions.

### 2 BACKGROUND ART

In the existing practices a transformation between two e.g compared systems is performed and the free energy between them is calculated. This value is calculated by simulating a system, that interpolates between the compared systems (the free energies of the end states correspond to these of the compared systems up to factors that usually cancel out), at a set of λ=[0,1] values (λ is the interpolating variable). The free energy between the intermediates is calculated and the total free energy difference is acquired.

From these values meaningful free energies are derived. In order for the results not to diverge and for the systems to be sampled well, soft core and sampling techniques are used (respectively). In addition in the existing practices in some contexts (usually when the previous procedure is not practical) Quantum Mechanical simulations are performed in order to calculate free energy difference.

### 3 DISCLOSURE OF THE INVENTION

The method suggests to possibly transform between each molecule/system and its replica with possibly some of the terms fully or partly relaxed in order to calculate the free energy difference between them.

The method suggets rules, which have not been stated before, in order for the transformation to give accurate results (according to the modeling). The free energy between the original and the transformed systems is calculated by simulating a system, that interpolates between them (the free energy of the end states correspond to the free energy of the system and its replica up to factors that cancel out or calculated), at a set of λ=[0,1] values. In one context based on these values and in the second context together with further calculations meaningful free energies are derived. In order for the results not to diverge and for the system to sampled well novel soft core and sampling techniques are used (respectively) (parts of the method). Using the method in the second context, QM calculations, which are very demanding computationally are usually not necessary. The transformation suggested in the method as well as the fact there are no simulations of systems which include ingredients of two molecules/systems (which are not needed in order to perform the calculation and complicate the calculation significantly), result in an accurate, simple, robust and efficient calculation.

### 4 BRIEF DESCRIPTION OF DRAWINGS

FIG. 1 is a scheme of the free energy differences in the calculation of binding free energy in the existing methods.

FIG. 2 is a scheme of the free energy differences in the novel method.

FIG. 3 is an example of the new coordinates of the atoms in the molecule Benzoic Acid in the comparison to Toluene.

FIG. 4 is a scheme of the transformation in a hybrid system in the dual topology (one system).

FIG. 5 is a scheme of the transformations in the novel method (two systems).

FIG. 6 is a scheme of the transformations in the dual topologies (one system).

FIG. 7 is a scheme of the free energy of the transformed Toluene in two environments.

FIG. 8 is an illustration of the energy and exp(−E/kT) as a function of distance for the potential r¹²-r⁻⁶ with E_{cap}=7 kCal/mol (a) at λ=1 (b) at λ=0.01.

FIG. 9 is an illustration of the transformations to the common denominator.

FIG. 10 is a plot of the integrated functions as a function of λ (a) Thermodynamic Integration (b) The novel method.

FIG. 11 is an illustration of the systems simulated in both methods.

### 5 BEST MODE FOR CARRYING OUT THE INVENTION

The method can be used according to the following steps:

### 5.1 Application of Solvation

1. Choose a group of molecules that will be compared (solvation free energy).
2. Acquire or generate coordinates and force fields for the molecules.
3. Divide the group into sub groups each having higher similarity etc. .
4. Perform simulations according to the method that will give as an output relative free energy value to all the molecules in each sub group.
5. Perform simulations according to the method that will compare one molecule from each sub group (calculate free energy difference).
6. Generate relative free energy value for the whole group of molecule.
7. Perform an experiment to get absolute free energy value for one of the molecule and deduce the absolute free energy values for all the molecules.

### 5.2 Application of Binding

1. Identify a molecule (e.g protein for binding) and its relevant site with which the drug molecule will interact.
2. Perform virtual screening of molecules according to the target molecule.
3. Acquire or generate coordinates and force fields for the target molecule and the filtered candidate drug molecules.
4. Place the candidate drug molecule at the binding site.
5. Perform simulations according to the method that will rank the candidate molecules according to the free energy value (low free energy values correspond to processes that are more likely to occur). (steps 4-5 can be performed using division of the group to more similar sub groups etc. similarly to steps 3-5 in the context of solvation).
6. Choose a certain number of the highest ranked molecules.
7. Perform experiments in order to determine which of the highest ranked molecules binds strongest to the target molecule and gives the desired effect.
   5.3 Application of chemical reactions
1. Identify a molecule and its relevant site with which the e.g drug molecule will interact.
2. Determine which molecules can chemically react with the target molecule.
3. Estimate what will be the products given the reactant molecules (target and drug).
4. Acquire or generate coordinates and force fields for the target molecule and the candidate drug molecules and the associated products.
5. Perform simulations using the method that will rank the candidate drug molecules according to the free energy value (low free energy values correspond to processes that are more likely to occur).
6. Choose a certain number of the highest ranked molecules.
7. Perform experiments to determine which of the highest ranked molecules reacts strongest with the target molecule and gives the desired effect.

### 5.4 Comments

1. Free energy calculations can be performed in more steps in which the more accurate steps are in a later steps.
2. Free energy values can be stored and used upon request.

### 6 INDUSTRIAL APPLICABILITY

Using the method computational free energy calculations can automated to a large degree. The applications that are relevant for the industry:

1. The method can be used for estimating solvation free energies of a group of molecules that is needed in many applications in chemistry.

2. The method can be used for computational drug discovery both in cases in which the drug molecule binds via inter molecular forces to the target molecule (e.g protein) and in cases in which the drug molecule chemically reacts with the target molecule.

3. The method can be used to computationally predict the strength of chemical reactions which is applicable also to organic chemistry and biochemistry.

4. The method may be used to predict probable molecular states e.g folded state of protein/RNA which is important for biochemical research performed in the industry.

5. Other applications.

### 7 DETAILED DESCRIPTION

7.1 First Context with example of applications of relative solvation and binding free energies

### 7.1.1 Summary

Calculating relative free energies is a topic of substantial interest and has many applications including solvation and binding free energies which are used in computational drug discovery. In relative free energy calculations the free energy is calculated by simulating one system that interpolates between the compared systems.

However, in the existing methods there remain the challenges of simplicity in the implementation, robustness and efficiency, which prevent the calculations from being automated and limit their use in computational drug discovery. Here a simple, robust and efficient method to calculate relative free energies will be introduced. In this method each system is first divided into a sub system that is similar and different between the compared systems. Then, each system is transformed in a separate simulation into its replica with the terms that couple the different sub system to the common sub system and the environment relaxed and the terms of the similar sub system identical to the terms of the other transformed sub system. Since in the transformed state the free energies of the two sub systems usually cancel out, we will be able to calculate meaningful free energy values.

### 7.1.2 Introduction

Calculating free energy differences between two physical systems, is a topic of substantial current interest. A variety of advanced methods and algorithms have been introduced to answer the challenge, both in the context of Molecular Dynamics and Monte Carlo simulations.¹⁻⁵ Applications of these methods include calculations of binding free energies,⁶⁻⁸ free energies of hydration,⁹ free energies of solvation,¹⁰ chemical reactions¹¹ and more. Binding free energy calculations are of high importance since they can be used for molecular docking¹² and in drug discovery.¹³ Free energy methods are extensively used by various disciplines and the interest in this field is growing—over 3,500 papers using the most popular free energy computation approaches were published in the last decade, with the publication rate increasing <17% per year.¹⁴

Free energy difference between two systems can be calculated using equilibrium methods (alchemical free energy calculations) and non equilibrium methods. In equilibrium methods a hybrid system is used to transform system A into B, usually with the transformation H_{hybrid}=λH_{A}+(1−λ)H_{B}, λ=[0,1]. In these methods, the hybrid system is simulated at a set of λ intermediates and average values are calculated. Then, using these values, the free energy difference is calculated. The commonly used methods include Bennett Acceptance Ratio,¹⁵ Weighted Histogram Analysis Method,¹⁶ Exponential Averaging/Free Energy Perturbation¹⁷ and Thermodynamic Integration (ThI).^{3,18,19} In non equilibrium methods the work needed in the process of switching between the two Hamiltonians is measured. These methods include Jarzynski relation²⁰ (fast growth is one of its applications²¹) and its subsequent generalization by Crooks.²² Most of the applications mentioned above can be tackled from a different direction using methods which measure the free energy as a function of a reaction coordinate. These methods include Adaptive Biasing Force²³ and Potential Mean Force¹⁸ (fast growth also belongs to this type of methods).

Calculating binding free energies is fundamental and has many applications. In particular it has potential to advance the field of drug discovery which has to cope with new challenges. In the last years the number of innovative new molecular entities (for pharmaceutical purposes) has remained stable at 5-6 per year. This situation is especially grim when taking into account the continual emergence of drug-resistant strains of viruses and bacteria.¹⁴ Virtual screening methods, in which the 10⁶⁰ possible molecules are filtered out, play a large role in modern drug discovery efforts. However, there remains the challenge of selecting the candidate molecules out of the still very large pool of molecules in reasonable times. Equilibrium methods show great potential in enabling the computation of binding free energies with reasonable computational resources. In these methods instead of simulating the binding processes directly, which would require a simulation many times the lifetime of the complex, the ligand is transmuted into another through intermediate, possibly nonphysical stages.¹⁴ This is in fact relative free energy calculation in which the difference between free energy of a process of one molecule and the free energy of the same process of the second molecule is calculated. If the free energy differences between the ligands in the two environments are calculated, the relative binding free energy between the two ligands can be calculated (this cyclic calculation is called the Thermodynamic Cycle).

In FIG. 1 a scheme of the free energies in the calculation of binding free energies in the existing methods is presented (L₁, L₂ and R represent the ligands and the receptor respectively). For solvation there is a similar scheme in which instead of the receptor there is solvent.

Free energy calculation methods already have successes in discovering potent drugs.¹³ However, despite the continuing progress in the field from the original concepts, the methods have restrictions which prevent them from being automatic and limit their use in computational drug design.¹⁴ A naive calculation of the free energy difference using ThI can be performed as follows:

$$\begin{matrix}Δ {F}_{A \to B ( β1 )} = {\int }_{0}^{1} \frac{d {F}_{A \to B} ( {H}_{hybrid} ( λ ) )}{d λ} d λ = & ( 1 ) \\ {\int }_{0}^{1} {\int }_{ }^{ } \frac{[ {H}_{B} ( Ω ) - {H}_{A} ( Ω ) ] {e}^{- {β}_{1} [ λ {H}_{B} ( Ω ) + ( 1 - λ ) {H}_{A} ( Ω ) ]} d Ω}{Z ( λ )} d λ & ( 2 )\end{matrix}$$

It can be seen that at λ=1 for example H_{A} does not affect the systems' behavior but its energy values are averaged over, which can result in large magnitudes of the integrated function. Thus, when the systems have low phase space overlap there are significant changes in the integrated function and large variance and hence large computational cost. This is especially dominant when the systems have different covalent bond description which results in a very low phase space overlap. A variety of approaches and techniques have been introduced to address the challenges in the field.

These include the topologies for simulating the system (single and dual topology which are hybrid topologies²⁴ and dual topologies²⁵), soft core potentials, the notion of decoupling atoms and more. Common sampling techniques to overcome high energy barriers include Temperature and Hamiltonian Replica Exchange methods (we will explain these methodologies in the course of the derivation of the method). However, the calculations in the existing practices are notoriously difficult to implement correctly.²⁴

Such complications arise for example from the fact that in the hybrid system there is one set of coordinates that describes both systems simultaneously and hence the hybrid system has to be designed. In addition since both systems interact simultaneously with the environment the behavior of the intermediate systems cannot be predicted.

Moreover, since the process of transforming one system into the other is different for each comparison and has no a priori known properties (e.g in the context of ThI this is equivalent to a function that needs to be integrated without any known properties), the choice of intermediates remains a challenge. In addition each type of hybrid topology has small phase space overlap in one aspect.²⁶ The dual topologies, that is simpler to implement, has a rather small phase space overlap since it involves transforming potential terms of all the atoms of the compared molecules and necessitates the use of restraints in binding free energy calculations.²⁵ Moreover, in the dual topology and in the dual topologies the interactions between some atoms have to be ignored in order for the calculations to be reasonable.^{24,25} While the soft core technique is efficient in removing singularities from the calculations it has various disadvantages. One of them is difficult implementation due to the complicated functions involved and the requirement to transform first the Coulomb terms and then the VDW terms in order to avoid singularities. In addition since it involves changing the shape of the functions it results in lower phase space overlap between intermediates.

Temperature Integration (Tel) was suggested in²⁷ as an efficient method to calculate free energy differences. Temperature Integration is based on calculating for each system the ln Z difference, between the temperature of interest and a high temperature using a Parallel Tempering procedure. Since at the high T limit the two systems with the same DOF have the same partition function, the free energy difference can be calculated. It is emphasized that the free energy difference calculated in Tel is between two different molecules while in relative free energy calculations the goal is to calculate free energy difference between the same molecule in two states (e.g solvated vs.

unsolvated or bounded vs. unbounded) compared to the free energy difference of another molecule in these two states. While TeI has many theoretical advantages, that will be apparent also in this method, it cannot be directly applied to molecular modeling in which bond stretching is allowed and to Molecular Dynamics. This is since the use of the capping in the covalent bond terms (in TeI we used the word cutoff and here we use capping since the cutoff is used in another context in MD simulations) will result in a phase transition which will result in impractical simulations in the canonical ensemble and since MD simulations at very high temperatures are impractical due to the very high velocities which will necessitate very small time steps for the integration of the equations of motion. In addition since in Tel, effectively, all the energy terms are relaxed, the phase space overlap between the compared systems is rather low.

Here, based on TeI, a general method that addresses these challenges will be presented. In this method instead of transforming between the end states that correspond to the compared systems to calculate the relative free energy difference, each system is simulated separately. As a result, the integrated function will necessarily be monotonic and the selection of intermediates will be simple. For these reasons and others the method is very simple to implement, robust, which has high importance in automation of free energy calculations, and efficient (high phase space overlap). It is emphasized that in this method there is a larger phase space overlap between the compared systems as compared to all the existing practices (and especially dual topologies). This is since less terms are removed in the transformation and since each system is inherently correlated with its transformed replica. The soft core scheme is also expected to achieve higher phase space overlap since the shape of the function is kept constant in the transformation. Thus the method has many advantages over the existing practices with the only possible cost of simulating two systems.

It is noted that the separate simulations are used here to calculate the free energy difference between two solvation/binding processes (and not only to calculate absolute solvation free energy e.g²⁸).

The method was derived from principles of statistical physics, and will be divided to its independent ingredients (each ingredient can be used with the other existing ingredients) with relation to the state of the art corresponding ingredients. In section 2 we explain how the two systems can be simulated separately to give the free energy difference in a simple, robust and efficient calculation. This ingredient is related to topology and can be called Two Topologies. In section 3 we explain which interactions have to be removed in the transformation of each system in order for the calculation to be legitimate. This ingredient is an extension to the decoupling scheme of the hybrid topologies, which does not include a completely analytic treatment,²⁴ and a considerable improvement over the decoupling schemes in TeI and the dual topologies. These ingredients are the main ones is and are explained analytically. In section 4 we present a technique that will ensure that the electric and VDW terms at λ→0 will not play a role.

This is a unified approach^{29,30} to soft core potentials which has been validated in the context of MD for certain values.³⁰ In section 5 we explain how if the systems have rugged energy landscape, instead of using the sampling techniques in another λ or T dimension, we can use only one sampling dimension (this is related to the first ingredient and optional). In section 6 we will summarize and discuss the method.

### 7.1.3 Two Separate Simulations

In relative free energy calculations the difference between solvation/ binding processes of two similar molecules is calculated. Our goal here is to calculate the relative free energy by transforming each system separately without having ingredients from the two compared systems in the simulation. First, in order to avoid reaching high temperatures (used in TeI), we use an additional variable λ that will transform the system, keeping the temperature constant. Second, in order to avoid the phase transition we will keep the covalent terms constant in the transformation so that the molecules will stay with the same connectivity in the transformation. The idea in the method is to transform each of the systems A and B in each environment (without environment and in solute for solvation and in solute and in a solute with a protein for binding) into two systems that have the same partition function up to factors that will cancel out in the Thermodynamic Cycle. Since we can calculate the free energy difference between each molecule and its transformed replica, we will be able to calculate the relative free energy difference. In the simulations we have only the atoms of the original molecule, which is a considerable simplification over the simulation in the hybrid system set up and a simplification over the dual topologies set up. For now we will assume that by relaxing some of the energy terms, the free energies of the transformed system at each environment can be decomposed to the free energy of the identical part between the systems and the free energy of the different part that will cancel out in the Thermodynamic cycle. We will also assume that at λ→0 the terms that are removed in the transformation do not play a role.

In the next sections we will justify these assumptions.

We now explain how the free energy difference between the original systems and their transformed replicas can be calculated in the context of Thermodynamic Integration. We emphasize that it can also be calculated with other free energy calculation methods (FEP, BAR etc.). We denote the Hamiltonian with the terms that are removed in the transformation by Hᵣ and the Hamiltonian including the other terms by H_{c}. The λ dependent Hamiltonian can be written as follows:

$$\begin{matrix}{H}_{A \text{/} B} ( λ ) = λ {H}_{{A}_{r} \text{/} {B}_{r}} + {H}_{{A}_{c} \text{/} {B}_{c}} & ( 3 ) \\ Δ {F}_{A \text{/} B -> {A}^{′} \text{/} {B}^{′}} = - {k}_{B} T [ {ln Z}_{A \text{/} B} ( β , λ = 1 ) - {ln Z}_{A \text{/} B} ( β , λ = 0 ) ] = & ( 4 ) \\ - {k}_{B} T {\int }_{- 1}^{1} \frac{d ln {Z}_{A \text{/} B}}{d λ} d λ = {\int }_{0}^{1} 〈 {H}_{r} 〉 & ( 5 )\end{matrix}$$

it can be seen that simulations of the system at a set of λs (in the range [0,1]) that interpolate between the original and transformed systems in which the average energies <Hr> will be calculated, will allow us to numerically integrate and get the free energy difference between the original system and the transformed system.

Using these free energy differences we can calculate the relative free energies between the systems (e.g the difference between solvation/binding free energy of one molecule and the other molecule). It is emphasized that the free energy difference calculated here is between A and A′ or between B and B′ as opposed to the standard calculation in which the free energy is calculated between A and B. In the transformation the energy terms are lowered (or unchanged) and as a result the corresponding partition functions value will change monotonically, which will enable a simple selection of intermediates for the calculation of the free energy difference. The simplicity in implementation and the monotonicity of the function have particular importance in automating free energy calculations.

In conclusion, we transform the two molecules one time at each environment (without environment and in solute for solvation and in solute and in a solute with a protein for binding). That is, each molecule is simulated at a set of λs and the free energy between the original and transformed systems is calculated. These free energy differences will allow us to get the relative free energy difference.

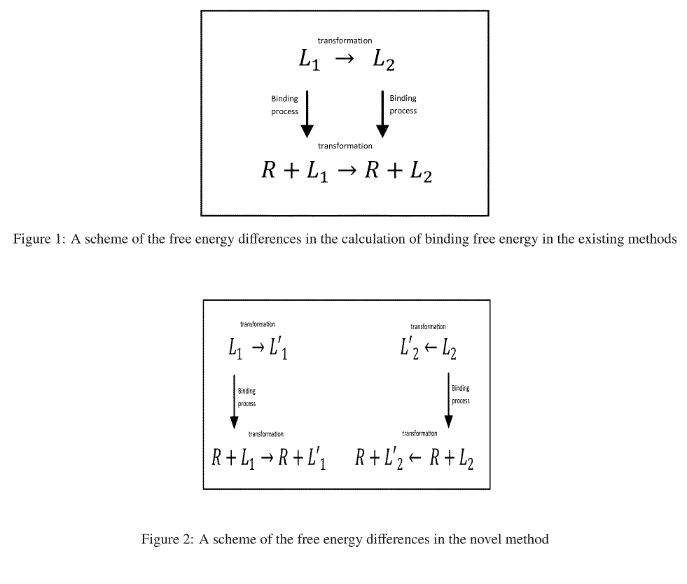

In FIG. 2 a scheme of the free energies in the novel method is presented. The ligand L₁/ L₂ is transformed into its replica L₁′/L₂′ with some energy terms relaxed. The free energy difference between L₁′ and L₂′ cancels out since the free energy of the transformed systems can be decomposed into free energy that is identical between the compared systems and one that will cancel out in the Thermodynamic Cycle (ΔF_{L′}_{₁}_{→L′}_{₂}=ΔF_{R+L′}_{₁}_{→R+L′}_{₂}).

It can be written as follows:

$$Δ {F}_{{L}_{1} -> R + {L}_{1}} - Δ {F}_{{L}_{2} -> R + {L}_{2}} = Δ {F}_{{L}_{1} -> {L}_{1}^{′}} - Δ {F}_{{L}_{1}^{′} -> {L}_{2}^{′}} - Δ {F}_{{L}_{2} -> {L}_{2}^{′}} - ( Δ {F}_{R + {L}_{1} -> R + {L}_{1}^{′}} - Δ {F}_{R + {L}_{1}^{′} -> R + {L}_{2}^{′}} - Δ {F}_{R + {L}_{2} -> R + {L}_{2}^{′}} ) = Δ {F}_{{L}_{1} -> {L}_{1}^{′}} - Δ {F}_{{L}_{2} -> {L}_{2}^{′}} - ( Δ {F}_{R + {L}_{1} -> R + {L}_{1}^{′}} - Δ {F}_{R + {L}_{2} -> R + {L}_{2}^{′}} ) \qquad ( 6 )$$

Now the relative free energy can be written as follows:

$$\begin{matrix}Δ {F}_{{A}_{solvation \text{/} binding} -> {B}_{solvation \text{/} binding}} = {\int }_{0}^{1} 〈 {H}_{{B}_{r}}^{′} 〉 - {\int }_{0}^{1} 〈 {H}_{{A}_{r}}^{′} 〉 + {\int }_{0}^{1} 〈 {H}_{{A}_{solvated \text{/} {bounded}_{r}}}^{′} 〉 & ( 7 ) \\ - {\int }_{0}^{1} 〈 {H}_{{B}_{solvated \text{/} {bounded}_{r}}}^{′} 〉 & ( 8 )\end{matrix}$$

### 7.1.4 Decoupling the Partition Function

Now we turn to explain how by removing certain terms in the transformation, the partition function of the transformed system can be decoupled into two partition functions. One partition function will be identical between the transformed systems at each environment and the difference between the second partition functions at each environment will be identical and will thus cancel out in the Thermodynamic Cycle. We will maximize the phase space overlap between the original and the transformed systems by removing as less terms as possible in the transformation (the phase space overlap is directly related to the number of intermediate systems needed in order to calculate the free energy difference). This is a considerable improvement (in terms of phase space overlap) over Temperature Integration and dual topologies and an extension to the decoupling scheme in the hybrid topology.³¹ In addition this treatment is analytic (accurate) as opposed to the existing decoupling schemes that are not treated completely analytically.²⁴

Molecular modeling includes covalent bond, bond angle, dihedral angle, electric and VDW potentials.^{32,33} Covalent bond, bond angle and dihedral angle potential terms are composed of the coordinates of two, three and four nearest covalently linked atoms respectively. Electric and VDW potentials relate between every atom pair in the system.

Thus the energy terms can be separated into short range terms (covalent bond, bond angle, dihedral angle and improper dihedral angle) and long range terms (electric and VDW). In the terminology of the field they are called bonded interactions and non bonded interactions respectively and it was decided to use these names in order to emphasize this difference between them which has importance for the derivation of the method. The covalent bond, bond angle and dihedral angle terms can be expressed in terms of the spherical variables r, θ and φ defined with respect to the relevant atoms. We now divide our systems to two subsystems—the sub systems that are common and different between the compared molecules.

We use the following change of variables:

$$d Ω = {\prod }_{i}^{n} d {r}_{i}^{′} = d {r}_{i}^{′} {\prod }_{i = 2}^{k} d {r}_{i} d {r}_{k + 1} {\prod }_{i = k + 2}^{n} d {r}_{i} = d {r}_{1}^{′} {Π}_{i = 2}^{k} d {r}_{i} {r}_{k + 1}^{2} sin {θ}_{k + 1} d {θ}_{k + 1} d {φ}_{k + 1} {Π}_{i = k + 2}^{n} d {r}_{i}$$

### Where

rᵢ=r′ᵢ−r′ᵢ₋₁ (9)

which will be chosen as the position of atoms relative to a covalently bounded atom. k represents the last atom that is common between the compared systems and k+1 represents that first atom in the different sub molecule. Integration over these degrees of freedom will of course give the same free energy.

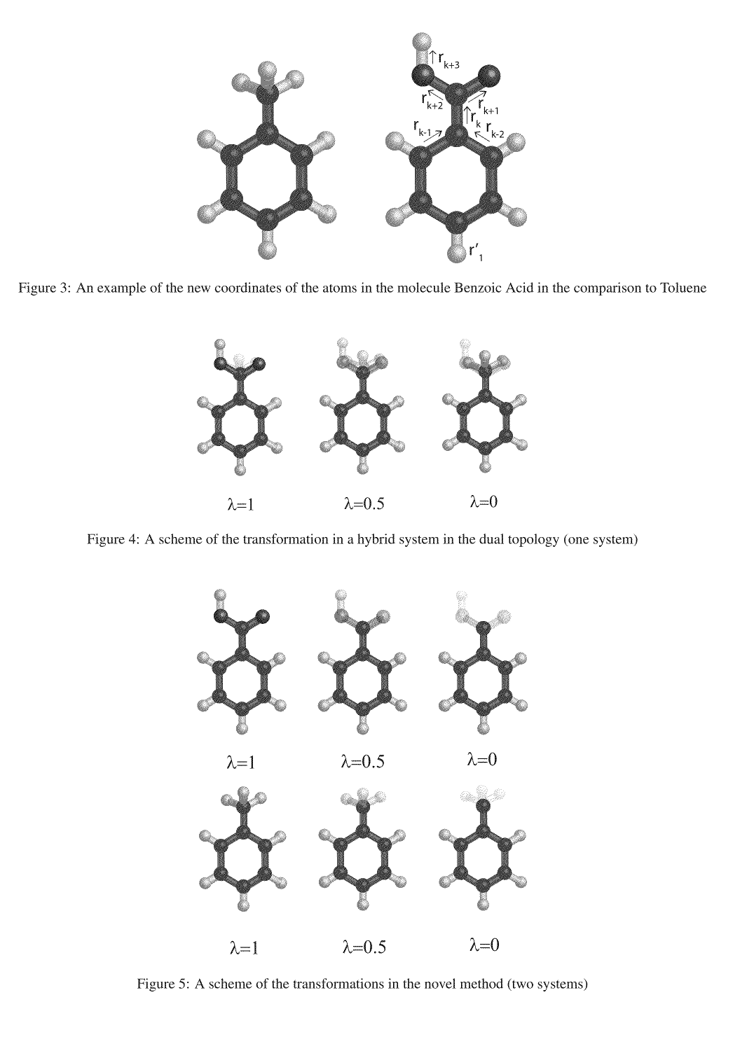

In FIG. 3 an example of the new coordinates of the atoms in the molecule Benzoic Acid in its comparison to Toluene is presented.

In the hybrid topologies, in order to decouple the partition function all the long range terms of the different atoms are relaxed in the transformation. In addition the short range terms that couple the different atoms to the common atoms are relaxed. Here in the transformation the long range energy terms between the different sub system and the atoms that are not in that sub system (the ones that are in the common sub system and in the environment) will be relaxed. In addition the short range terms that involve the common and the different atoms can remain constant in the transformation. While it is easy to understand the first extension (long range energy terms between the atoms of the different sub system can remain constant in the transformation) from the change of variables, the second extension will be explained in more detail. Assuming that we have dihedral and bond angle terms that relate between atoms in the two sub systems. Then, for a given set of coordinates of the atoms in the common sub system, if we vary the coordinates of the atoms in the different sub molecule, we will get the same overall contribution to the partition function independently of this set of coordinates. Hence, since the contribution to the partition function does not depend on the location of the atoms in the common sub system, these energy terms, effectively, do not couple the partition functions. This is despite the fact that bond and dihedral angle energy terms involve atoms from the two sub systems.

If we ensure that at the separation point between the common and different subsystems there will be only one dihedral term (there will be one dihedral term that is associated with the rₖ covalent bond which is usually the case) and there will not be an improper dihedral energy term that will couple atoms from the common and different submolecules (if this is not the case we can relax them in the transformation), we will be able to separate the partition functions. The first of these two conditions can be understood as follows.

Varying the coordinates of the atoms in the different sub system will give us a factor that does not depend on the information of the directions of two axes (e.g rₖ and rₖ₋₁), but in the case of information on three directions (e.g also rₖ₋₂) there will be dependence.

We can write in terms of the partition functions:

Z(r′₁, r₂, . . . , rₙ)=Z_{common int}(r′₁, r₂, . . . , rₖ)Z_{dif non int}(rₖ₊₁, . . . , rₙ) (10)

where Z_{commonint} denotes the partition function of the common sub molecule that interacts with the environment, Z_{diff nonint} denotes the partition function of the different sub molecule that does not interact with the environment and the rest of the molecules and the arrow symbolizes the transformation in which the long range energy terms are relaxed. It is noted that in fact the dihedral and bond angle terms that include atoms from the common and the different sub molecules are included in Z_{diff nonint} (rₖ₊₁, . . . , rₙ) but the orientations of the relevant axes that are originally in the common sub system can be effectively associated also with the different sub system (only of theoretical importance).

In the case of totally different molecules it can thus be written:

Z→Z_{diff non int}

It can be seen that Z_{commonint} will cancel out in the calculation since it is identical between the compared systems. Since the systems are simulated in two environments in the Thermodynamic Cycle Z_{diff nonint} cancels out. In the terminology of the field removing the long range energy terms is called decoupling and the decoupled atoms are called dummy. In this context we can call the different sub system dummy sub system since we keep the internal long range energy terms constant in the transformation (for simplicity the internal long energy terms can also be removed). In addition in some cases the long range terms between the different atoms and the common environment (e.g water in binding) may be kept constant and may have a small effect on the free energy. However, this is not analytical and is therefore not recommended in the general case.

In FIG. 4 a scheme of the transformation of the hybrid system that compares Benzoic Acid and Toluene is presented at λ values of 0,0.5 and 1. The transparent atoms at the end state are dummy atoms and at the intermediate λ=0.5 the different atoms between the two sub systems are partly interacting. These calculations are often used when the compared systems have a relatively small difference (e.g molecules that differ in few atoms).

In FIG. 5 a scheme of the two separate systems suggested in the novel method (for the same compared molecules) is presented. It is emphasized that in all topologies there is no restriction on the number of atoms of the compared molecules since these factors cancel out in the Thermodynamic Cycle.

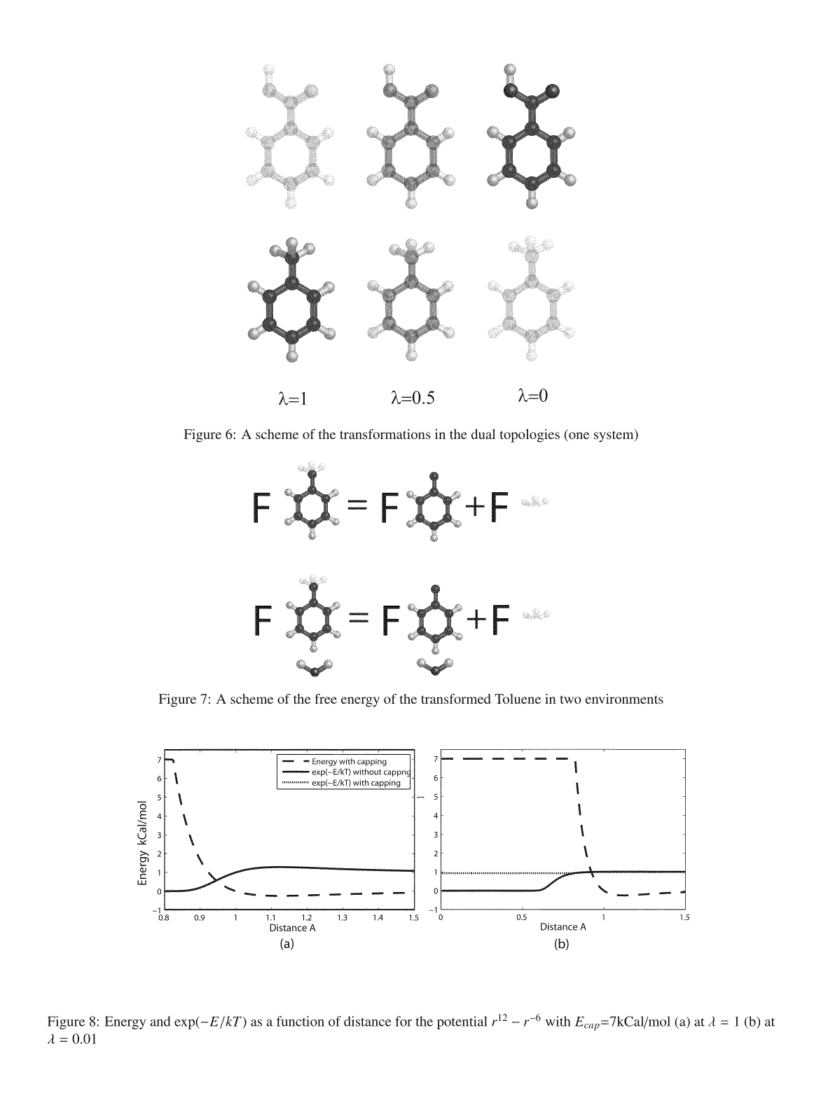

In FIG. 6 a scheme of the dual topologies is presented. It can be seen that long range energy terms of all the atoms in the ligand are relaxed in the transformation which results in low phase space overlap (as the molecule is larger this effect is more dominant). The two molecules are simulated in one system so their interactions have to be ignored in order for the calculations to be reasonable.

In FIG. 7 a scheme of the free energies of the transformed replica of Toluene at the two environments is presented. It can be seen that in both environments the free energy of the transformed replica can be decomposed into the free energy of the common and the different sub systems. The free energy of the different sub system is equal in the two environments since it effectively does not interact and therefore cancels out in the Thermodynamic Cycle.

### 7.1.5 Removing Singularities at Small λs

Here we will present a unified approach^{29,30} to remove the singularities at small λs. This is in fact a soft core technique. As compared to the existing soft core techniques, this technique keeps the original shape of the potential constant, which is better in terms of phase space overlap. In addition the need to remove first the electric terms and then the VDW terms to avoid singularities²⁴ is eliminated. Here, the implementation is also expected to be simpler.

Since even at λ→0 the energy terms that diverge at r=0 are still dominant and cause a difference between the partition functions of the two systems, capping is used in the long range energy terms (if E>E_{cap}E=E_{cap}). Thus, the partition functions at λ→0 are equal up to factors that will cancel out in the Thermodynamic Cycle. The proposed calculation of the free energy difference between the two systems is legitimate only if the choice of the capping energy has a negligible effect on the partition function value of each of the two systems at λ=1. The Hamiltonian with the capping in all the long range energy terms H′ is written as follows (we can also cap only the energy terms that are removed):

H′_{A/B}(β,λ)=λH′_{A}_{ₗᵣ}_{/B}_{ₗᵣ}+H_{A}_{ₛᵣ}_{/B}_{ₛᵣ} (11)

The requirement stated above can be written explicitly as follows:

lnZ_{A/B}(β,λ=1,H′)≅lnZ_{A/B}(β,λ=1,H) (12)

It can be seen that at λ=0:

lnZ_{A}(β,λ=0,H′)−lnZ_{B}(β,λ=0,H′)=ΔlnZ(β,0,H′)_{A}_{_{diff non int}}_{→B}_{_{diff non int}} (13),(14)

In order for the capping to have a negligible effect on the partition functions at λ=1 it has to be set to a value that satisfies:

$${e}^{- \frac{{E}_{cap}}{{k}_{B} T}} << 1 \qquad ( 15 )$$

$${e}^{- \frac{λ {E}_{cap}}{{k}_{B} T}} << 1$$

Thus at λ values satisfying the corresponding interactions, including the steric, become transparent.

In FIG. 8 energy and exp(−E/kT) as a function of distance for the potential r¹²-r⁻⁶ are plotted at λ=1 and at λ=0.01. It can be seen that the capping of the energy has a negligible effect on the probability distribution at λ=1 and that at small λs it enables the equation of the partition functions.

It is suggested that since the probability to be in a microstate decays exponentially with the energy with typical decay scale of k_{B}T and since the density of states for E>E_{cap} is very low, capping the energy relative to the the average pair total long range energy will have a negligible effect on the free energy at λ=1. It has been shown in the context of MC that there is a tradeoff when choosing E_{cap} (behavior of the function vs. accuracy)²⁹ and that values of 5 kCal/mol²⁹ enable accurate free energy calculations (results were independent of the capping energy). The fact that the force is zero in some of the range is legitimate in MD simulations since the particles have thermal velocities and they are affected by other potentials (also there exist other potentials without force at certain distances e.g the VDW and the Coulomb potentials at large distances). It is noted that in order to have continuity in the derivative that will enable the integration over the equations of motion in MD to be valid, a switching function between the standard long range potential and the flat potential is needed. This has been developed independently and implemented in MD with a cubic switching function and an energetically inaccessible capping energy, which validates the use of the capping in the context of MD for high energetic values (40 kCal/mol).³⁰ Thus a unified approach that uses a quadratic switching function and a capping energy that is accessible and has a negligible effect on the free energy is suggested as a soft core technique.

The potential in the existing soft core technique is given by:

$$H ( λ , r ) = 4 ε {λ}^{n} [ {( {α ( 1 - λ )}^{m} + {( \frac{r}{σ} )}^{6} )}^{- 2} + {( {α ( 1 - λ )}^{m} + {( \frac{r}{σ} )}^{6} )}^{- 1} ]$$

It can be seen that the derivative of this potential is rather complicated (used in ThI) and that the shape of the potential changes with in the transformation which results in lower phase space overlap. In addition in order to avoid singularities, first the Coulomb terms have to be removed and only then the VDW terms can be removed.²⁴

### 7.1.6 Sampling Rugged Energy Landscape in One λ Dimension

When the systems, between which the free energy difference is calculated, have rugged energy landscape, one can use techniques such as H-REMD/H-PT (Hamiltonian Replica Exchange MD/Hamiltonian Parallel Tempering, variant of Parallel Tempering/Replica Exchange³⁴⁻³⁶) to alleviate sampling problems.³⁷ In this technique the system is simulated at a set of λs and exchanges of configurations between them are performed every certain number of steps according to the Metropolis criterion. In this regard this is in fact a system that is composed of the systems at the different λs which are non interacting. Thus, the systems at the low λs, that can cross energetic barriers, help the system of interest to be sampled well. This technique, even though is highly efficient, introduces another sampling dimension since the simulations of the replicas at a set of λs are performed at each intermediate of the hybrid system (sampling the dimensions of λ that interpolates between the systems and of λ of the replicas that are used for the equilibration). Here, the simulations at the different λs will be used also to calculate the free energy difference by integration and the need for another sampling dimension is eliminated.

In order to equilibrate the entire system the energy terms that are not multiplied by λ can be written as follows:

$${H}_{c} \to f ( λ ) {H}_{c} , f ( λ ) = \{ \begin{matrix}λ & λ \geq {λ}_{eq} \\ {λ}_{eq} & λ < {λ}_{eq}\end{matrix}$$

where λ_{eq} denotes the minimal λ for equilibration in the H-REMD procedure. Here we transformed only up to λ_{eq} in order to have a minimal transformation (as compared with TeI). Thus the H-REMD procedure is in its original form in the range λ=[1,λ_{eq}] and the systems at λ=[λ_{eq},0] can be simulated separately since the energy barriers are accessible for these λ values. It is noted that the free energy difference calculated in the H-REMD procedure, which is in the range λ=[1,λ_{eq}], and in the simulations in the range λ=[λ_{eq},0] can be used for comparison to another molecule that has a similar part with the moleule and to another molecule that has the same similar sub molecule respectively. Covalent bond and bond angle energy terms may not need equilibration (multiplication by λ) as they are not expected to be associated with rugged energy landscape.

### 7.1.7 Discussion

A novel method for calculating relative free energies is presented. This method can be used to calculate the free energy difference between solvation/binding free energy of two molecules with any number of atoms and is applicable to MD and MC simulations and to all types of molecular modeling. The article is composed of several independent ingredients. The main ingredient is to use the two separate systems instead of one system that includes ingredients of the two systems in order to calculate the relative free energy. This, when combined with the decoupling scheme presented here (the second ingredient), has the advantages of simplicity, robustness and efficiency (these ingredients are explained analytically). The third ingredient is a unified approach to soft core potentials. We also show how if the systems have rugged energy landscape, instead of using the sampling techniques in another λ or T dimension, we can use only one sampling dimension.

In equilibrium methods the hybrid topologies have one set of coordinates that specifies the configurations of the two systems so the hybrid system needs to be designed. In the dual topologies the phase space overlap is rather low as the transformation involves all the atoms of the compared molecules. Also, in the dual topology/ies the interactions between the atoms that are different between the compared systems have to be removed in order for the calculations to be reasonable. In addition, the Hamiltonian involves potentials with more complicated lambda dependence and their derivatives have to be calculated. Moreover, simulating one system with the end states being the two compared molecules may be problematic in automation as the intermediate systems may be significantly different than the end states due to indirect interaction between the compared molecules (interaction through the environment). This method has the advantage of simplicity since the simulations are performed only on the two (almost) original systems in two separate simulations and the need for extensive design and to ignore interactions between the compared systems is eliminated. In addition, the integrated function sampled in this method is necessarily monotonic. These two advantages are of high importance for automation of free energy calculations and computational drug discovery. It can be clearly seen that the number of the energy terms that are removed in this method is smaller than all the existing decoupling schemes (and especially as compared with the dual topologies) and that the transformed systems are inherently correlated with the original ones. In addition, the capping scheme keeps the shape of the potentials constant in the transformation which is advantageous for phase space overlap. Thus, we have many advantages over the existing methods with the only possible cost of having to simulate two systems.

Moreover, since the λs used in the H-REMD/H-PT procedure are also used as intermediates in the calculation of free energy difference, a convergence for systems with rugged energy landscape is achieved without introducing another sampling dimension. Both in the calculation of the integral for the free energy difference and in the H-REMD/H-PT procedures, the chosen intervals between the λs have to be smaller where the internal energy varies significantly, in the free energy difference calculation in order to have good sampling of the function and in H-REMD in order to maintain optimal acceptance rates. Thus, no additional unnecessary λs have to be sampled.

Using this method (preceded by virtual screening filtering) an automated free energy calculation that will result in the best candidates may be performed. It is noted that the method may have other applications in physics.

7.2 Second Context with the Example of Application of Free Energy of Chemical Reactions

### 7.2.1 Summary

Calculating free energy differences is a topic of substantial interest and has many applications including chemical reactions which are used in organic chemistry, biochemistry and medicines. In equilibrium free energy methods that are used in molecular simulations, one molecule is transformed into another to calculate the energy difference. However, when the compared molecules have different number of atoms, these methods cannot be directly applied since the corresponding transformation involves breaking covalent bonds which will cause a phase transition and impractical sampling. Thus, Quantum Mechanical Simulations, which are significantly more demanding computationally, are usually combined to calculate free energies of chemical reactions. Here we show that the free energies can be calculated by simple classical molecular simulations followed by analytic and/ or numerical calculations. In this method, where applicable, a system that will have a similar shared subsystem is identified. Then the other unshared subsystem(s) is identified (if there will not be a similar system the system will be defined as unshared). The terms belonging to similar subsystems (if exist) are transformed to predetermined values such that these subsystems will be identical and terms of the unshared subsystem will be relaxed such that this subsystem will be decoupled into non interacting subsystems. The free energy between the original and transformed system(s) and possibly the free energy associated with the transformed unshared subsystem are calculated, enabling the calculation of meaningful free energy values. Since molecular force fields can often be automatically generated and the calculations suggested here are rather simple the method can form a basis for automated free energy computation of chemical reactions.

### 7.2.2 Introduction

Free energy calculations have a variety of applications which include binding, solvation, chemical reactions and more. In equilibrium methods one molecule is transformed into another to get the free energy difference. When the goal is to calculate the free energy difference of a chemical reaction, we can directly transform between the molecules. However, if the molecules have different number of atoms, a direct transformation will involve breaking bonds and as a result phase transition and impractical sampling. Thus, Quantum Mechanical calculations are usually combined with molecular simulations in free energy calculations of chemical reactions. One way to calculate the free energy difference of a chemical reaction in the general case is to calculate the solvation free energies of the molecules using molecular simulations. Then, the free energy difference between the molecules in the gas state is calculated with Quantum Mechanical methods. Thus, using the Thermodynamic Cycle the free energy difference between the molecules in the liquid state can be calculated.¹¹ Alternatively, QM/MM simulations in which the relevant part of the system has QM force fields can be performed. These simulations also generate information on the dynamics of the simulated system.³⁸ Here we suggest that the free energy difference can be calculated by classical molecular simulations followed by analytic or numerical calculations.

### 7.2.3 A Separate Simulation for Each Molecule

The idea in the method is to transform the reactants and the products (between which the free energy difference is calculated) into molecules that have the same partition functions up to factors that can be calculated. For now we will assume that by relaxing some of the energy terms, the free energies of the transformed system (molecule) can be decomposed to the free energy of the identical part between the systems (identical sub molecule) and to the free energy of the different part (different sub molecule) that can be calculated. Then, we will justify this assumption. First, we will match reactant molecules with similar product molecules. In some chemical reactions all the reactant molecules will be matched, and in some (usually when there are more reactants than products or vice versa) there will also be unmatched molecules. For example, given the chemical reaction

A+B→C+D (18)

We can usually match molecule A, B to molecules C, D respectively.

Then, we can transform the systems into the systems A′, B′, C′ and D′ by relaxing the potential terms of the atoms that are different between the systems and calculate the free energy differences ΔF_{A′→}A_{′},ΔF_{B′→}B_{′},ΔF_{C→}C_{′} and ΔF_{D→}D_{′}. Then, if F_{A′} and F_{C′} can be decomposed into free energy of the common sub molecule between A and C and free energies that can be calculated (and similarly for F_{B′} and F_{D′}), we will be able to get the free energy difference. Another example is the following the chemical reaction:

A+B→C (19)

We can usually match molecule A to C and B will be left unmatched. Then we can transform the systems into the systems A′, B′ and C′ by relaxing potential terms of the atoms that are not in the common sub molecule and calculate the free energy differences ΔF_{A′→}A_{′},ΔF_{B′→}B_{′} and ΔF_{C→}C_{′}. Then, if the matched molecules can be decomposed into free energy of the common sub molecule and the different part (that can be calculated) and the free energy of the transformed unmatched molecules can be calculated, we will be able to calculate the free energy difference.

We now explain how the free energy difference between the original systems and their (alchemically) transformed replicas can be calculated using Thermodynamic Integration. We denote the Hamiltonian with the terms that are removed in the transformation by Hᵣ and the Hamiltonian including the other terms by H_{c}.

The λ dependent Hamiltonian can be written as follows:

H_{A/B}(λ)=λH_{A}_{ᵣ}+H_{A}_{_{c}} (20)

Using the following derivation:

$$Δ {F}_{A \to {A}^{′}} = - {k}_{B} T [ ln {Z}_{A} ( β , λ = 1 ) - ln {Z}_{A} ( β , λ = 0 ) ] = - {k}_{B} T {\int }_{0}^{1} \frac{d ln {Z}_{A} ( β , λ )}{d λ} d λ = {\int }_{0}^{1} 〈 {H}_{r} 〉 d λ \qquad ( 21 )$$

it can be seen that simulations of the system at a set of λs (in the range [0,1]) that interpolate between the original system and the transformed system in which the average energies <Hᵣ> will be calculated, will allow us to numerically integrate and get the free energy difference between these systems.

### 7.2.4 The Remaining Free Energy Difference

Now we turn to explain how the free energy of the transformed matched molecule can be decomposed into two free energies (the free energy of the different submolecule will be calculated and the free energy of the common sub molecule will cancel out) and how the free energy of the transformed unmatched molecule can be calculated.

Molecular modeling includes covalent bond, bond angle, dihedral angle, electric and VDW potentials.^{32,33} Covalent bond, bond angle and dihedral angle potential terms are composed of the coordinates of two, three and four nearest covalently linked atoms respectively. Electric and VDW potentials relate between every atom pair in the system. For reasons that will be clear later the energy terms can be separated into uncoupling terms—covalent bond, bond angle, dihedral angle and coupling terms—electric and VDW. For the purpose of this method we will associate the improper dihedral angle terms with the coupling terms.

Now we can switch to relative coordinates (coordinates of atoms relative to other covalently bounded atoms) and then to spherical coordinates.

$$d Ω = {\prod }_{i}^{n} {dr}_{i}^{′} = {dr}_{1}^{′} {\prod }_{i = 2}^{k} {dr}_{i} {\prod }_{i = k + 1}^{n} {dr}_{i} = {\prod }_{i = 1}^{k} {dr}_{i}^{′} {\prod }_{i = k + 1}^{n} {r}_{i}^{2} sin {θ}_{i} drd {θ}_{i} d {φ}_{i} \qquad ( 22 )$$

### Where

rᵢ=r′ᵢ−r′ᵢ₋₁ (23)

which will be chosen as the position of atoms relative to a covalently bounded atom. k represents the last atom that is common between the compared systems and k+1 represents that first atom in the different sub molecule. In the case that the molecule is unmatched k+1 will be the first atom.

The decoupled molecule/submolecule is first divided into elements of standard covalent bonds, bond junctions and of more complex structures that include molecular rings. Since each of the uncoupling terms depends on one independent variable, the integration in each element is independent of the others. Thus the integrals can be performed separately and then multiplied to yield the partition function and hence the free energy difference. We write these free energy factors explicitly:
Covalent bond The partition function of a covalent bond in Spherical Coordinates can be written as follows:

$${Z}_{c} = \int {e}^{- \frac{β {{k}_{c} ( r - d )}^{2}}{2}} {r}^{2} d r = \frac{{π}^{2} [ ( 2 {d}^{2} β {k}_{c} + 1 ) ( erf ( d \sqrt{β {k}_{c}} ) + 1 ) + 2 \sqrt{π} {e}^{- β {k}_{c} {d}^{2}} d \sqrt{β {k}_{c}} ]}{{{l}^{3} ( β {k}_{c} )}^{3 / 2}} \qquad ( 24 )$$

where l is an arbitrary length (l³ cancels out in comparisons).
Two Bonds Junctions When considering the case of a Linear/Bent molecular shapes, it can be seen that in most cases when varying the bond angle, the rest of the molecule moves as a rigid body. Since the spherical coordinates representation includes three independent variables, varying a bonding angle is decoupled from all the other degrees of freedom of the molecule. Hence the calculation of free energy factors, which arise from bonding potential terms that are different between the compared molecules, is straightforward. One of the most common bonding angles potentials is the following:

V_{b}(θ)=½k_{θ}(θ−θ₀)². (25)

So the integration over the corresponding degree of freedom can be written as:

$${Z}_{b} = \int {e}^{- β {V}_{b}} d Ω = {e}^{- \frac{β {k}_{θ}}{2} {( θ - {θ}_{0} )}^{2}} sin θ d θ = \frac{1}{2 \sqrt{β {k}_{θ}}} {e}^{- i θ - \frac{1}{2 β {k}_{θ}}} \sqrt{\frac{π}{2}} ( i Erf ( \frac{i - {θ}_{0} β {k}_{θ} + β {k}_{θ} π}{\sqrt{2 β {k}_{θ}}} ) + Erf i ( \frac{1 + i {θ}_{0} β {k}_{θ}}{\sqrt{2 β {k}_{θ}}} ) - i 2 {e}^{i {θ}_{0}} ( Erf ( \frac{1 + i {θ}_{0} β {k}_{θ}}{\sqrt{2 β {k}_{θ}}} ) - i Erf i ( \frac{1 + i β {k}_{θ} ( π - {θ}_{0} )}{\sqrt{2 β {k}_{θ}}} ) ) ) \qquad ( 26 )$$

This expression is real for positive and real values of k , β and θ.

When varying a dihedral angle, the potential term value depends on the orientation of first bond (which determines the axis from which the dihedral angle is measured). However, since the integration has to be performed over all the range [0,2π], varying the φ angle will yield a factor which is independent of the location of the first bond. Thus, the integration does not depend on the direction of the first bond and is straightforward.

V_{d}(φᵢⱼₖₗ)=k_{φ}(1+cos(nφ−φₛ)) (28)

The integration over this degree of freedom yields the following result:

Z_{d}=∫e^{-βV}^{_{d}}dΩ=∫e^{-βk}^{_{φ}}^{(1+cos(nφ-φ}^{ₛ}⁾⁾dφ=2πe^{βk}^{_{φ}}I₀(βk_{φ}) (29)

where I0 (βkφ) is Bessel function of the first kind at βkφ which is defined as follows

The commonly used dihedral angles potential is of the following type:

$$I ( x ) = {\sum }_{l = 0}^{∞} \frac{{( - 1 )}^{l}}{{2}^{2 l} {( l ! )}^{2}} {x}^{2 l} \qquad ( 30 )$$

Three or more Bonds Junctions Molecule shapes can include monomer that splits into more than one monomer. Such examples are the trigonal planar, tetrahedral trigonal pyramidal etc. These cases will necessitate numerical integration which can be performed using the Spherical law of cosines that can be written as follows:

cos(θ₁₂)=cos(θ₁)cos(θ₂)+sin(θ₁)sin(θ₂)cos(Δφ) (31)

where θ₁,θ₂ denote the bond angles of two bonds with respect to the principal bond and θ₁₂,Δφ denote the bond angle and the difference in φ angle between these two bonds respectively. Usually in these cases there is one dihedral angle energy term which is between one of the bonds, the principal bond and a previous bond. Since the integration over the other degrees of freedom yields a factor that is independent of the value of φ, the integrations can be treated as decoupled. Thus, the integration for the case of one monomer that splits into two can be written as follows:

Z=∫e^{-β(V}^{_{b}}^{+V}^{_{d}}^{)dΩ=}Z_{d}^{Z}^{_{b}} (32)

where

Z_{d}=2πe^{-βk}^{_{φ}}I₀(βk_{φ})

and

Z_{b}=∫e^{-β/2|k}^{₁}^{⁰}⁽⁰^{₁}⁻⁰^{₁}^{⁰}⁾^{²}^{+k}^{₂}^{⁰}⁽⁰^{₂}⁻⁰^{₂}^{⁰}⁾^{²}^{+k}^{₁₂}^{⁰}⁽⁰^{₁₂}⁻⁰^{₁₂}^{⁰}⁾^{²}^{|} sin(θ₁)sin(θ₂)dθ₁dθ₂dφ₂ (33)

For the general case it can be written as follows:

$${Z}_{b} = \int {\prod }_{i} {e}^{- \frac{β}{2} {{k}_{i}^{θ} ( {θ}_{i} - {θ}_{i}^{0} )}^{2}} {\prod }_{i > j} {e}^{- \frac{β}{2} {{k}_{ij}^{θ} ( {θ}_{ij} - {θ}_{ij}^{0} )}^{2}} {\prod }_{i} sin {θ}_{i} d {θ}_{i} {\prod }_{i \geq 2} d φ I \qquad ( 34 )$$

where θᵢⱼ can be calculated from (31). In case there are any energy terms that introduce complexity they can be relaxed in the transformation.

In addition, the partition function of complex structures at λ=0 can often be calculated numerically. Other internal bonding energy terms can also be included in these numerical integrations (and also not be multiplied by λ). In many cases the common sub systems include the complex structures, eliminating the need for these calculations.

These free energy factors can be substituted in:

$${F}_{{B}^{′} \to {A}^{′}} = {k}_{B} T [ {\sum }_{i} ln {Z}_{{B}_{{c}_{i}}} + {\sum }_{i} ln {Z}_{{B}_{{b}_{i}}} + {\sum }_{i} ln {Z}_{{B}_{{d}_{i}}} - ( {\sum }_{i} ln {Z}_{{A}_{{c}_{i}}} + {\sum }_{i} ln {Z}_{{A}_{{b}_{i}}} + {\sum }_{i} ln {Z}_{{A}_{{d}_{i}}} ) ] \qquad ( 35 )$$

to give the remaining free energy difference (where A′ and B′ are transformed matched molecules).

Thus, we can write in terms of the partition functions:

$$Z \to {Z}_{common int} {\sum }_{i = 1}^{l} {Z}_{{c}_{i}} {\sum }_{i = 1}^{m} {Z}_{{d}_{i}} {\sum }_{i = 1}^{p} {Z}_{2 {b}_{i}} {\sum }_{i = 1}^{q} {Z}_{3 {b}_{i}} {\sum }_{i = 1}^{r} {Z}_{{complex}_{i}}$$

where Z_{commonint} represents the partition function of the common part between the compared molecules that is interacting with the environment and Z_{ci} and Z_{di} represent the ith covalent bond and dihedral angle partition function respectively. Z_{2bi} and Z_{3bi} represent the ith two bond and three or more bond junctions respectively and Z_{complexi} represents the ith complex structure partition function. The arrow represents the transformation λ=1→0.

When the molecule is unmatched, we will relax all the coupling terms and calculate the free energy in a similar manner.

This calculation can be written as follows:

$$Z \to {Z}_{free particle} {\sum }_{i = 1}^{l} {Z}_{{c}_{i}} {\sum }_{i = 1}^{m} {Z}_{{d}_{i}} {\sum }_{i = 1}^{p} {Z}_{2 {b}_{i}} {\sum }_{i = 1}^{q} {Z}_{3 {b}_{i}} {\sum }_{i = 1}^{r} {Z}_{{complex}_{i}}$$

where Z_{freeparticle}=V (see²⁴ for typical values of V).

Thus, comparison between any group of reactants and product can be performed by transforming each molecule in a separate simulation, followed by calculation of the free energies associated with the different sub molecules. Since the relaxed energy terms involve diverging terms at r→0, even at λ→0 these terms will still be dominant. Thus, in order for the calculations to be legitimate, soft core potentials have to be used (see for example). In the case of rugged energy landscape, sampling techniques such as H-REMD have to be used in another λ dimension. In this free energy calculation method this sampling technique can be used in the same λ dimension. The method has been demonstrated and compared with ThI for the calculation of free energy difference between two molecules of two atoms in a spherical potential (see Appendix for more details).

7.3 Practical Example with a General Force Field

### 7.3.1 Description

The following is a description of how to transform a group of similar molecules (e.g phenol derivatives) according to the method described. This is relevant for both contexts as it explains how to compare a number of molecules that have similar common sub systems.

Similar groups (e.g benzene and phenol derivatives) can either be grouped together or linked later on (preferably the second option) and so on.

The goal here is to satisfy the following:
1. Performing an exact calculation.
2. Performing a calculation that can be automated.
3. Performing a general calculation, applicable to all the existing force fields.
4. Performing the smallest transformations possible.
5. Performing a transformation that will necessarily result in a monotonic change in the integrated function.
6. Performing a transformation that will only necessitate one transformation of each molecule at each environment.

In order to satisfy all of the above, we will focus on two groups of potential terms:
1. Different terms that belong to the common sub system.
2. Terms that couple the common sub system to the different sub system.

The guiding rule for the transformation will be to relax the existing terms up to the common denominator. Relaxing terms will include multiplication by a positive number in the range [0,1]. Thus, the terms will necessarily stay with the same sign (or be completely relaxed).

The common denominator will satisfy the following:
1. The common sub system will be identical between all the systems.
2. The two sub systems will be decoupled.

The rules for performing the transformation are the following:
1. Different terms that belong to the common sub system will be relaxed up to the lowest value of all the molecules. If the term has different sign among the molecules, as can be only in the case of partial charge, it will be completely relaxed.
2. Terms that belong to the different sub systems and do not couple between the systems will not be transformed.
3. Terms that couple the common sub system to the different sub system will be completely relaxed. These terms usually include the non bonded terms and improper dihedral/s. However the identification of these terms is a subtle issue.

### 7.3.2 Demonstration

We will now demonstrate the method for comparing the solvation free energy of Crestol and Choloro-para-Phenol.

We will present on the illustration only the terms that will be transformed (the rest will be terms that are identical in the common sub system and terms of the different sub system that do not couple between the systems). Similar transformations apply for a group of 3,4 etc. para-phenols (the terms of all the molecules have to be taken into account).

We will use an auto-generated force field presented in the article: An Automated force field Topology Builder (ATB) and repository/ JCTC 2011, 7(12). This type of force field is the most varying among similar molecules and it was chosen in order to show the generality of the method.

We will not present the VDW terms in order to have a clearer figure. These terms are simpler to transform as compared with the partial charge as they do not change sign.

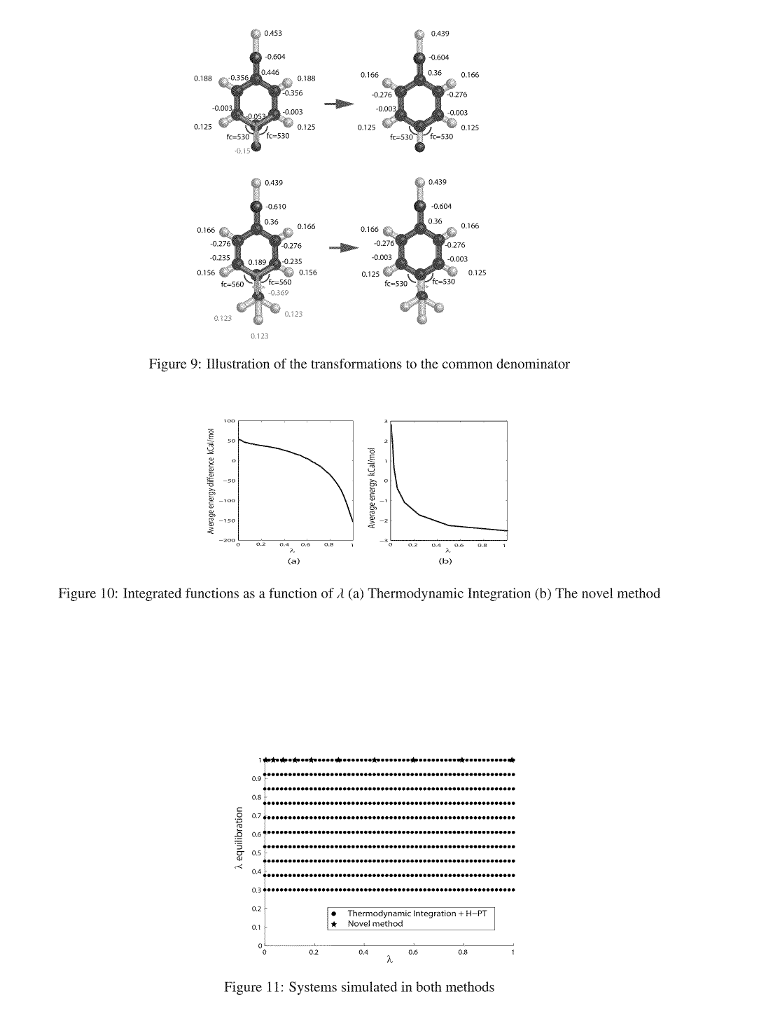

In FIG. 9 an illustration of the transformations to the common denominator is presented. The terms in black are the terms that belong to the common sub system. The terms in grey are the coupling terms and the dashed line is the dihedral term. The partition function of this dihedral term is independent of the partition function of the transformed common sub system (it can also be effectively associated with the different sub system). As a result it will cancel out between the same molecule in the two environments and can remain constant. It is noted that the angle terms marked on the figure have the same values of average angle and different values of the spring constant (corresponds to f_{c}) which after the transformation are the same. The three connected lines in grey represent the improper dihedral term that couples between the two sub systems and will be relaxed in the transformation. It is emphasized that the treatment will be much simpler in standard force fields and this example is given in order to show the general case.

### 7.4 Comments on the Generality of the Method

The description of the method has been in the context of full atomistic modeling with force field that is varying between similar molecules and for certain applications. It will be explained here that the method is applicable to many types of modeling, force fields and applications. The method is applicable to many types of modeling which include (but not limited to) e.g coarse grained modeling that assumes fixed bond lengths and bond angles. The treatment in these cases is usually similar to the description above.

In addition, and as mentioned before, standard force fields usually vary less than the one described. The procedure in these force fields is usually simpler and is usually a private case of the description above. Moreover, the method described above is not limited to the described applications and not to the described contexts and may serve to calculate free energy in other contexts (e.g in structure prediction²⁹). Moreover, the method is not limited to the linear multiplication by λ and may better have different (assumingly of higher polynomial order) dependency on λ. It is noted that the integration limits do not necessarily have to be zero and one and e.g instead of zero there can be negative λ values corresponding to the different terms (this is not relaxing terms as usually defined) .In addition in the case that the terms are not zero in the transformed end state, each term can be divided into a constant term and a term that is e.g decreased in the transformation to give the desired effect.

### 7.5 Appendix

### 7.5.1 Demonstration and Comparison (Second Context)

In order to demonstrate the method it was used with all its ingredients in MC simulation to calculate the free energy difference between the systems A and B and this value was compared to the one calculated by numerical integration. Then, in order to assess the efficiency of the method, the free energy difference between the systems was calculated using ThI combined with H-PT (in MC simulation) and the running time of the two methods was compared. It is emphasized that the use of ThI is feasible only since we compare one molecule to another and since the molecules have the same number of atoms.

The compared systems are composed of a molecule of two atoms in which one atom is fixed to the origin and the second one is bound to the first by a covalent bond.

The second atom in each system is in a θ dependent potential (in spherical coordinates), containing θ⁻¹² term to represent the VDW repulsive term used in molecular modeling. The potential barrier was chosen to be of typical value of systems with tens of atoms, having rugged energy landscape. The covalent bond length difference was chosen to represent systems with few different atom lengths—see the next section for more details (the values of the pairs of spring constant and covalent bond length were taken from molecular simulation software). The following potential and parameters were used:

$$\begin{matrix}{V}_{A} = \frac{1}{2} {k ( {r}_{12} - {r}_{{eq}_{A}} )}^{2} - 5.5 {k}_{B} T [ sin 4 θ - \frac{{10}^{- 8}}{{( θ - \frac{3 π}{8} )}^{12}} ] & ( 36 ) \\ {V}_{B} = \frac{1}{2} {k ( {r}_{12} - {r}_{{eq}_{B}} )}^{2} - 5.5 {k}_{B} T [ sin 4 θ - \frac{{10}^{- 8}}{{( θ - \frac{5 π}{8} )}^{12}} ] \\ {r}_{{eq}_{A}} = 2.1 A , {r}_{{eq}_{B}} = 1.3 A , {k}_{A} = \frac{123 kcal}{mol {A}^{2}} , \\ {k}_{B} = 428 \frac{123 kcal}{mol {A}^{2}} , {E}_{cutoff / capping} = 7 kcal \text{/} mol & ( 37 )\end{matrix}$$

Here we used the partition function of two atoms with a covalent bond term represented by a harmonic potential that can be written as follows:

$$\begin{matrix} Z ( β ) = \int {e}^{- \frac{β {k ( r - d )}^{2}}{2}} {d}^{3} x = \frac{4 π}{{l}^{3}} \int {e}^{- \frac{β {k ( r - d )}^{2}}{2}} {r}^{2} d r , & ( 38 ) \\ = \frac{π [ ( 2 {d}^{2} β {k}_{c} + 1 ) ( erf ( d \sqrt{β {k}_{c}} ) + 1 ) + 2 \sqrt{π} {e}^{- β {k}_{c} {d}^{2}} d \sqrt{β {k}_{c}} ]}{{{l}^{3} ( β {k}_{c} )}^{\frac{3}{2}}} & ( 39 )\end{matrix}$$

where l is an arbitrary length. This was used to calculate the free energy difference between the systems with the coupling terms relaxed.

The comparison of the method to the numerical integration yielded exactly the same results. The running time of the calculation of the free energy difference performed by the two methods was compared and yielded a factor of <30 in favor of the novel method. This factor originates from the extra sampling dimension and the larger number of intermediates needed in ThI combined with H-PT.

In FIG. 10 the functions integrated in the two methods are plotted. It can be seen that the difference in magnitude of the integrated function in the novel method is much smaller than this in ThI (factor of <40).

In FIG. 11 a scheme of the systems simulated in the two methods is presented (each point represents a simulation).

The dissimilarity between the systems that grows with the number of different particles, increases both the number of intermediates (due to a much larger difference in magnitude) and the number of simulation steps (increased variance) as compared with these in the novel method. The difference in the covalent bond description, that reduces the correlation between the systems significantly (the penalties are also not bounded by the capping energy) and has the most dominant effect, has a completely negligible computational cost in the novel method. Thus, the efficiency is increased in 3 multiplicative dimensions. It is here to remind that while the method is highly efficient, its biggest advantage is that it enables comparisons of molecules with different number of atoms in the same environment and that it does not require to transform a molecule to another.

### 7.5.2 Correspondence Between the Toy Model and Realistic Systems in the Comparison to Thermodynamic Integration

In the case of realistic compared systems in which the molecules differ in the covalent bond length of one atom (usually when comparing two systems with different connectivity there are many such differences), when the coupling terms of the atoms that are different between the molecules are relaxed (disregarding the equilibration procedure both in the existing methods and in the novel method for simplicity), the comparison of the methods will yield results that are very similar to the toy model. This is since (H_{B}−H_{A}┌(λ) in Thermodynamic Integration will be mainly affected by the changes between the systems. Thus, the functions integrated over in the toy model give good estimation to the ones in the comparison of the realistic systems mentioned above. Since the value of the functions integrated by Thermodynamic Integration is dominated by the covalent bond change (the rest of the difference in the energy terms is negligible as compared with it) it can be written:

<H_{B}−H_{A}>(λ)|_{realistic}≅<H_{B}−H_{A}>(λ)|_{toy model} (40)

Now we turn to show the correspondence in the novel method. We denote the energy terms of the atoms that are different between the realistic compared systems by H_{Ad/Bd}. Since these terms are the only ones in the integrated function it can be written:

(H_{A/ B})(λ)|_{realistic}=<H_{A}_{_{d}}_{/B}_{_{d}}>(λ)|_{realistic}≈<H_{A/B}>(λ)|_{toy model} (41)

In this case there will be similar values since the energy values of the non covalent energy terms are bounded by E_{cap}^{?} and thus the average value is of typical value of E_{capping}. Here the covalent bond energy term is not included in H_{Ad/Bd}. The parameters in the toy model for the covalent bond lengths and strengths are realistic and were taken from simulation software.

### REFERENCES

[1] Christophe Chipot and Andrew Pohorille. Free energy calculations: theory and applications in chemistry and biology, volume 86. Springer, 2007.
[2] Daniel M Zuckerman. Equilibrium sampling in biomolecular simulations. Annual review of biophysics, 40:41-62, 2011.
[3] D. Frenkel and B. Smit. Understanding molecular simulation: from algorithms to applications. Academic Press, Inc. Orlando, Fla., USA, 1996.
[4] M. R. Shirts, D. L. Mobley, and J. D. Chodera. Alchemical free energy calculations: Ready for prime time? Annual Reports in Computational Chemistry, 3:41-59, 2007.
[5] Kurt Binder and Dieter W Heermann. Monte Carlo simulation in statistical physics: an introduction. Springer, 2010.
[6] Peter Kollman. Free energy calculations: applications to chemical and biochemical phenomena. Chemical Reviews, 93(7):2395-2417, 1993.
[7] Y. Deng and B. Roux. Computations of standard binding free energies with molecular dynamics simulations. The Journal of Physical Chemistry B, 113(8):2234-2246, 2009.
[8] C. J. Woods, M. Malaisree, S. Hannongbua, and A. J. Mulholland. A water-swap reaction coordinate for the calculation of absolute protein-ligand binding free energies. Journal of Chemical Physics, 134(5):4114, 2011.
[9] T P Straatsma and H J C Berendsen. Free energy of ionic hydration: Analysis of a thermodynamic integration technique to evaluate free energy differences by molecular dynamics simulations. The Journal of chemical physics, 89:5876, 1988.
[10] Ilja V Khavrutskii and Anders Wallqvist. Computing relative free energies of solvation using single reference thermodynamic integration augmented with hamiltonian replica exchange. Journal of chemical theory and computation, 6(11):3427-3441, 2010.
[11] William L Jorgensen, James M Briggs, and Jiali Gao. A priori calculations of pka's for organic compounds in water. the pka of ethane. Journal of the American Chemical Society, 109(22):6857-6858, 1987.
[12] X. Y. Meng, H. X. Zhang, M. Mezei, and M. Cui. Molecular docking: A powerful approach for structure-based drug discovery. Current Computer-Aided Drug Design, 7(2):146-157, 2011.
[13] William L Jorgensen. Efficient drug lead discovery and optimization. Accounts of chemical research, 42(6):724-733, 2009.
[14] John D Chodera, David L Mobley, Michael R Shirts, Richard W Dixon, Kim Branson, and Vijay S Pande. Alchemical free energy methods for drug discovery: progress and challenges. Current opinion in structural biology, 21(2):150-160, 2011.
[15] C. H. Bennett. Efficient estimation of free energy differences from monte carlo data. Journal of Computational Physics, 22(2):245-268, 1976.
[16] S. Kumar, J. M. Rosenberg, D. Bouzida, R. H. Swendsen, and P. A. Kollman. The weighted histogram analysis method for free-energy calculations on biomolecules. i. the method. Journal of Computational Chemistry, 13(8):1011-1021, 1992.
[17] R. W. Zwanzig. High-temperature equation of state by a perturbation method. i. nonpolar gases. The Journal of Chemical Physics, 22:1420, 1954.
[18] J. G. Kirkwood. Statistical mechanics of fluid mixtures. The Journal of Chemical Physics, 3:300, 1935.
[19] T P Straatsma and J A McCammon. Multiconfiguration thermodynamic integration. The Journal of chemical physics, 95:1175, 1991.
[20] C. Jarzynski. Nonequilibrium equality for free energy differences. Physical Review Letters, 78(14):2690, 1997.
[21] D A Hendrix and C. Jarzynski. A fast growth method of computing free energy differences. The Journal of Chemical Physics, 114:5974, 2001.
[22] G. E. Crooks. Path ensembles averages in systems driven far-from-equilibrium. Arxiv preprint cond-matl9908420, 1999.
[23] E. Darve and A. Pohorille. Calculating free energies using average force. The Journal of Chemical Physics, 115:9169, 2001.
[24] Michael R Shirts. Best practices in free energy calculations for drug design. In Computational Drug Discovery and Design, pages 425-467. Springer, 2012.
[25] Gabriel J Rocklin, David L Mobley, and Ken A Dill. Separated topologies—a method for relative binding free energy calculations using orientational restraints. The Journal of Chemical Physics, 138:085104-1-9, 2013.
[26] David A Pearlman. A comparison of alternative approaches to free energy calculations. The Journal of Physical Chemistry, 98(5):1487-1493, 1994.
[27] A. Farhi, G. Hed, M. Bon, N. Caticha, C. H. Mak, and E. Domany. Temperature integration: an efficient procedure for calculation of free energy differences. Physica A: Statistical Mechanics and its Applications, 392:5836-5844, 2013.
[28] Heiko Schafer, Wilfred F Van Gunsteren, and Alan E Mark. Estimating relative free energies from a single ensemble: hydration free energies. Journal of computational chemistry, 20(15):1604-1617, 1999.
[29] A. Farhi. Msc thesis. Arxiv preprint cond-matl1212.4081, pages 15-43, 2011.
[30] Floris P Buelens and Helmut Grubmüller. Linear-scaling soft-core scheme for alchemical free energy calculations. Journal of Computational Chemistry, 33(1):25-33, 2012.
[31] Stefan Boresch, Franz Tettinger, Martin Leitgeb, and Martin Karplus. Absolute binding free energies: a quantitative approach for their calculation. The Journal of Physical Chemistry B, 107(35):9535-9551, 2003.
[32] James C Phillips, Rosemary Braun, Wei Wang, James Gumbart, Emad Tajkhorshid, Elizabeth Villa, Christophe Chipot, Robert D Skeel, Laxmikant Kale, and Klaus Schulten. Scalable molecular dynamics with namd. Journal of computational chemistry, 26(16):1781-1802, 2005.
[33] Berk Hess, Carsten Kutzner, David Van Der Spoel, and Erik Lindahl. Gromacs 4: Algorithms for highly efficient, load-balanced, and scalable molecular simulation. Journal of chemical theory and computation, 4(3):435-447, 2008.
[34] A. M. Ferrenberg and R. H. Swendsen. New monte carlo technique for studying phase transitions. Physical review letters, 61(23):2635, 1988.
[35] U. H. E. Hansmann. Parallel tempering algorithm for conformational studies of biological molecules. Chemical Physics Letters, 281(1-3):140-150, 1997.
[36] D. J. Earl and M. W. Deem. Parallel tempering: Theory, applications, and new perspectives. Physical Chemistry Chemical Physics, 7(23):3910-3916, 2005.
[37] H. Fukunishi, O. Watanabe, and S. Takada. On the hamiltonian replica exchange method for efficient sampling of biomolecular systems: Application to protein structure prediction. The Journal of chemical physics, 116:9058, 2002.
[38] Arieh Warshel and Michael Levitt. Theoretical studies of enzymic reactions: dielectric, electrostatic and steric stabilization of the carbonium ion in the reaction of lysozyme. Journal of molecular biology, 103(2):227-249, 1976.

1-14. (canceled)

15. A method of calculating a difference in free-energy at molecular level, the method comprising:
computationally transforming, by a computer, a first molecule into a first replica molecule being similar to the first molecule, and a second molecule into a second replica molecule being similar to the second molecule;
separately calculating, by said computer, a difference in free-energy between said first molecule and said first replica molecule at an environment, and a difference in free-energy between said second molecule and said second replica molecule at said environment; and
based on said calculated differences, calculating, by said computer, a total free-energy difference between said first and said second molecules at said environment.

16. The method according to claim 15, further comprising repeating said computational transformation and said calculation of difference in free-energy for each of said additional molecule.

17. The method according to claim 15, wherein for at least one of said first and said second molecule, said transforming comprises relaxing potential terms of atoms not in common among first said molecule and second said molecule, said relaxing comprises multiplying said potential terms by positive numbers in the range [0,1].

18. The method according to claim 15, wherein for at least one of said first and said second molecule, said transforming comprises keeping terms selected from the group consisting of: non quadratic uncoupling bonded terms and terms between atoms in the sub-molecule not in common among the first and second said molecules.

19. The method according to claim 15, further comprising calculating contribution to said total free-energy difference from non-canceled dissimilarities between a statistical partition function of said first replica molecule and a statistical partition function of said second replica molecule.

20. The method according to claim 19, wherein the dissimilar part in the partition functions in one or both replicas is composed of a plurality of sub-systems, independently calculating, by said computer, a free-energy value for each of said sub-systems, by computing at least one statistical partition function selected from the group consisting of: a statistical partition function describing uncoupling bonded terms in said sub-system, a statistical partition function describing non-quadratic uncoupling bonded terms in said sub-system, a statistical partition function describing bond junctions in said sub-systems and a statistical partition function describing a complex structure.

21. The method according to claim 15, further comprising capping non-bonded terms at accessible energy.

22. A method of calculating a difference in free-energy at molecular level, the method comprising:
computationally transforming, by a computer, a first molecule into a first replica molecule being similar to the first molecule, and a second molecule into a second replica molecule being similar to the second molecule, wherein the potential terms of the replicas are determined based on the potential terms of the two molecules;
for each environment of a first environment and a second environment, separately calculating, by said computer, a difference in free-energy between said first molecule and said first replica molecule at said environment, and a difference in free-energy between said second molecule and said second replica molecule at said environment; and
based on said calculated differences, calculating, by said computer, a total free-energy difference between an interaction process when involving said first molecule and said interaction process when involving said second molecule.

23. The method according to claim 22, wherein said interaction process is solvation of a respective molecule in a solvent.

24. The method according to claim 23, further comprising dissolving said first molecule in said solvent, so as to determine a free-energy value associated with said first molecule; and
using said total free-energy difference for associating a free-energy value with said second molecule.

25. The method according to claim 22, wherein said interaction process is binding of a respective molecule to a receptor.

26. The method according to claim 22, wherein said free energy difference calculation and sampling rugged energy landscape are performed in one dimension, by relaxing terms up to a multiplication by a positive number in the range (0,1] resulting in a smooth energy landscape;
and further completely relaxing coupling terms between the atoms not in common between the first and second molecules and the group consisting of atoms in common and the environment atoms, keeping uncoupling bonded terms constant.

27. The method according to claim 22, wherein for at least one of said first and said second molecule, said transforming comprises keeping terms selected from the group consisting of: quadratic and non-quadratic uncoupling bonded terms and terms between atoms in the sub-molecule not in common among the compared molecules.

28. The method according to claim 22, wherein for at least one of said first and said second molecule, said transforming comprises relaxing potential terms of atoms not in common among said molecule and a respective replica of said molecule, said relaxing comprises multiplying said potential terms by positive numbers in the range [0,1].

29. A drug-screening method, comprising the method of claim 22.

30. The method according to claim 29, wherein said first environment contains a target molecule, and said second environment is devoid of said target molecule, and wherein the method comprises:
ranking said molecules based on said calculated differences; and
reacting a highest-ranked drug molecule with said target molecule.

31. The method according to claim 30, wherein said transforming comprises keeping terms selected from the group consisting of: quadratic and non-quadratic uncoupling bonded terms and terms between atoms in the sub-molecule not in common among the compared molecules.

32. The method according to claim 22, wherein a dissimilarity between a statistical partition function of said first replica molecule and a statistical partition function of said second replica molecule is cancelable in a thermodynamic cycle calculation.

33. The method according to claim 22, further comprising capping non-bonded terms at accessible energy.

34. A method of calculating free-energy of a molecular model describing a molecule, the method comprising:
removing, by a computer, coupling terms from the molecular model, thereby providing a similar replica molecule having a plurality of sub-systems;
calculating, by said computer, a difference in free-energy between the molecule and said replica;
independently calculating, by said computer, a free-energy value for each of said sub-systems thereby providing a plurality of free-energy values, by computing for said subsystem at least one statistical partition function selected from the group consisting of: a statistical partition function describing uncoupling bonded terms in said sub-system, a statistical partition function describing non-quadratic uncoupling bonded terms in said sub-system, a statistical partition function describing bond junctions in said sub-system and a statistical partition function describing a complex structure in said sub-system; and
based on said difference in free-energy and said free-energy values, calculating, by said computer, the free-energy of the molecular model.
